(19) United States
(12) Patent Application Publication
(10) Pub. No.: US 2006/0143242 A1
(43) Pub. Date: Jun. 29, 2006

(54) Content management device

(75) Inventor: Kouji Hara, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/127,110

(22) Filed: May 12, 2005

(30) Foreign Application Priority Data
Dec. 27, 2004 (JP) JP2004-376420

(51) Int. Cl. G06F 17/30

(52) U.S. Cl. 707/203

(57) ABSTRACT

To enable a flexible snapshot to be invoked through a simple site configuration by storing a difference updated when updating a content as history information. When updating a content stored on a storage unit into a new content, history information is created by comparing the new content with a content when updating, request information for the content is received, the history information corresponding to the request information is searched from the storage unit, the content is regenerated based on the history information as a result of the search, and the regenerated content is provided to a requester.

### BACKGROUND OF THE INVENTION

The invention relates to a technology of managing contents when providing the contents via a network.

Over the recent years, with spread of WWW (World Wide Web) on the Internet, a various categories of information (contents) can be provided promptly to users in a broad range. For instance, product information, support information, etc. are provided one after another on maker sites.

On these sites, the user can use those pieces of information any time simply by inputting URLs (Uniform Resource Locators) onto the so-called Web Browser.

These pieces of information are generally updated into new information as new products are put on sale and specifications thereof change. In this case, however, if only the new information is left simply as a substitute for the old information, it follows that neither the users of the old products nor the users who desire to compare the new products with the old products can use the information of the old products.

The content and the URL are, however, uniquely fixed, and hence, if the old information is to remain undeleted, this requires maintenance of replacing a piece of information about a certain URL with a new piece of information and, at the same time, storing the replaced old information in a way that associates the old information with a different URL.

Moreover, the information increases day by day as the old information is left, with the result that a tremendous quantity of information must be managed. Therefore, a technology for facilitating the management on the occasion of updating the information was demanded.

The prior arts related to the invention of this application are, e.g., technologies disclosed in Patent documents 1 through 6 given below.

[Patent document 1] Japanese Patent Application Laid-Open Publication No. 2002-132570

[Patent document 2] Japanese Patent Application Laid-Open Publication No. 2002-55869

[Patent document 3] Domestic Laid-Open Publication of Japanese Translation of PCT Application No. 2002-511616

[Patent document 4] Japanese Patent Application Laid-Open Publication No. 2000-194643

[Patent document 5] Japanese Patent Application Laid-Open Publication No. 2004-21900

[Patent document 6] Japanese Patent Application Laid-Open Publication No. 2003-6033

### SUMMARY OF THE INVENTION

Patent document 1 describes a system for saving the past information as image data and storing the data given a history. Therefore, this system has such a problem that only the past information can simply displayed, link information (hyperlinks) can not be utilized, and the text data can not be copied.

Moreover, Patent document 2 describes a service for creating an archive with a date used as a key and redirecting to a page specified by this date. In the service in Patent document 2, the past information is simply stored on a date-by-date basis, and hence a problem is that it is difficult to use the link information described in the past information and to search other than by the date.

Further, Patent document 3 describes a general system for caching data used for communications between a server and a user terminal, however, any consideration is not given to the link information and a Web page dependent relation, and this system can not be applied to the management of the contents.

Such being the case, the invention aims at providing a technology for facilitating the content management by creating history information when updating the content and providing a past content on the basis of this history information.

To solve the problems, the invention adopts the following configurations. Namely, a content management device according to the invention comprises:
a storage unit for storing a content;
a history creation module for creating, when updating the content stored on the storage unit into a new content, history information by comparing the new content with a content when updating;
a request accept module for receiving request information for the content;
a search module for searching the storage unit for the history information corresponding to the request information;
a content regeneration module for regenerating the content based on the history information as a result of the search; and
a providing module for providing the regenerated content to a requester.

The history creation module may compare the new content with the content when updating, and may thus create difference data between the two contents and search data as the history information.

The search module may acquire request trend data by executing a statistical process of the retrieved request information, and may register the request trend data on the storage unit.

Further, a content management method according to the invention makes a computer execute:
a step of creating, when updating a content stored on the storage unit into a new content, history information by comparing the new content with a content when updating;
a step of receiving request information for the content;
a step of searching the storage unit for the history information corresponding to the request information;
a step of regenerating the content based on the history information as a result of the search; and
a step of providing the regenerated content to a requester.

In the content management method, the history information creating step may involve comparing the new content with the content when updating, and thus creating difference data between the two contents and search data as the history information, and the history information searching step may involve acquiring request trend data by executing a statistical process of the retrieved request information, and storing the request trend data on the storage unit.

Further, the invention may be a content management program to execute the content management method by a computer. Moreover, the present invention may be a recording medium storing the content management program that is readable by the computer. Then, by causing the computer to read out the program from the recording medium and to execute the program, it is possible to provide a function of the program.

Here, the computer readable recording medium refers to a recording medium, in which information such as data or a program can be accumulated by an electrical, magnetic, optical, mechanical or chemical action, and the information can be read out by the computer. Examples of the recording media among such recording media, which are capable of being removed from the computer, include a flexible disc, a magneto-optical disc, a CD-ROM, a CD-R/W, a DVD, a DAT, an 8 mm tape, and a memory card.

In addition, a hard disc, a read only memory (ROM) and the like may be given as the recording media to be fixed to the computers.

The invention is capable of flexibly invoking a snapshot with a simple configuration of a site by storing a difference updated when updating a content as history information.

### BRIEF DESCRIPTION OF THE DRAWINGS

FIG. 1 is an explanatory view of an outline of a public server according to the invention.

FIG. 2 is a functional block diagram of a public server 1.

FIG. 3 is an explanatory diagram of history information.

FIG. 4 is an explanatory diagram of request trend data.

FIG. 5 is an explanatory diagram of lexical analysis data.

FIG. 6 is an explanatory diagram of a content management method.

### DETAILED DESCRIPTION OF THE PREFERRED EMBODIMENT

A best mode for carrying out the invention will hereinafter be described with reference to the drawings. A configuration of the following embodiment is an exemplification, and the invention is not limited to the configuration of the embodiment.

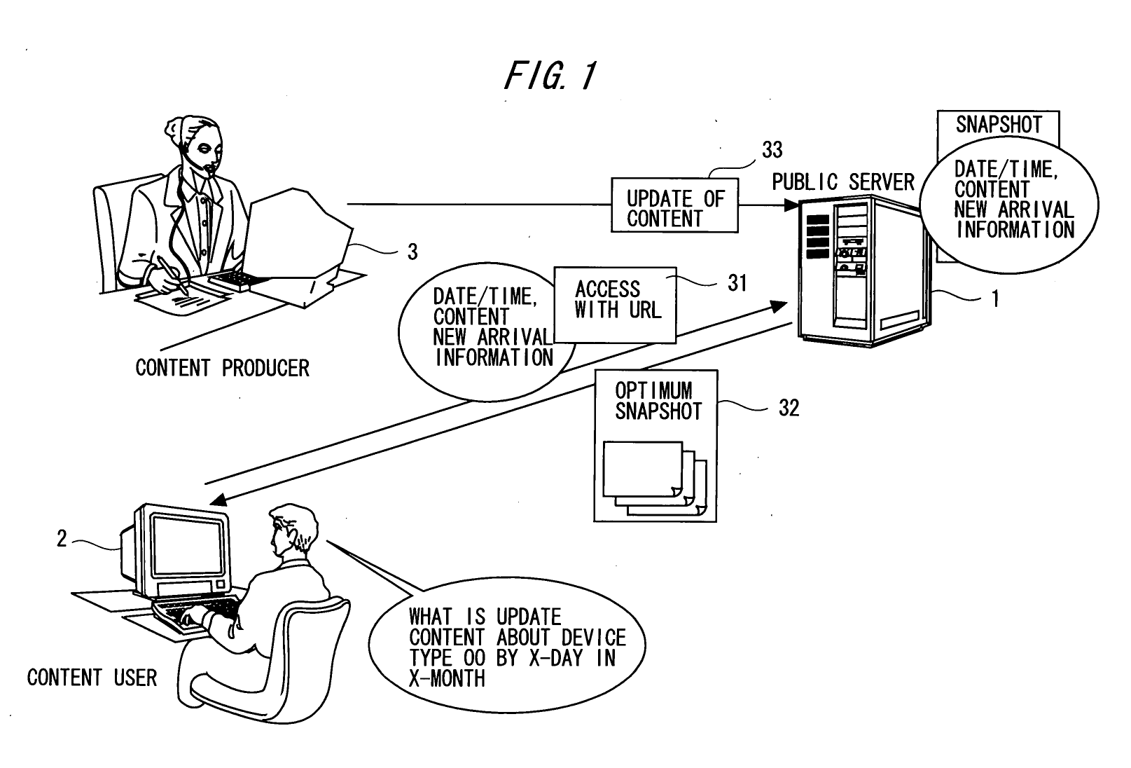

FIG. 1 is an explanatory view of an outline of a public server according to the invention. A public server 1 in the embodiment, upon receiving a request 31 for a content from a user terminal 2, provides the user terminal 2 with a content 32. Further, when a content producer uploads a new content 33 for updating into the public server 1 from on a producer terminal 3, the public server 1 creates history information by comparing the new content with the pre-updating content, and stores the history information. Then, when a request for a past content is given from the user terminal 2, the public server 1 searches the history information for information corresponding to the request. The public server 1 regenerates a content based on the history information corresponding thereto, and provides this content to the requester.

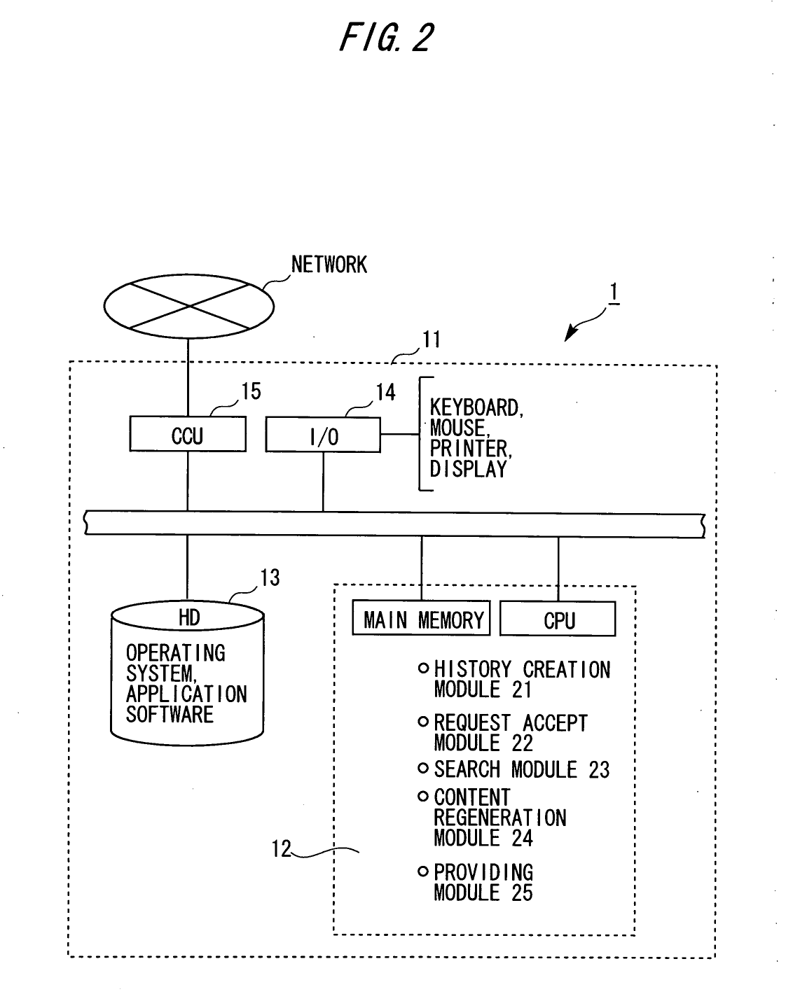

FIG. 2 is a functional block diagram of the public server 1 in the embodiment. As shown in FIG. 2, the public server 1 is a general type of computer including a main body 11 accommodating a calculation processing unit 12 constructed of a CPU (Central Processing Unit), a main memory, etc., a storage unit (a hard disc) 13 stored with data and software for a calculation process, an input/output port 14, a communication control unit (CCU) 15, and so on.

An input device such as a keyboard, a mouse, etc. and an output device such as a display device, a printer, etc. are properly connected to the I/O port 14.

The CCU 15 serves to perform communications with other computers via a network.

The storage unit 13 is installed with operating system (OS) and application software (a content management program). Further, a database for storing the contents and the history information is built up in the storage unit 13.

The calculation processing unit 12 properly reads the OS and the application program from the storage unit 13 and executes the OS and the application program, and carries out the calculation process of the information inputted from the I/O port 14 and from the CCU 15 and also the information read from the storage unit 13, thereby functioning as a history creation module 21, a request accept module 22, a search module 23, a content regeneration module 24 and a providing module 25.

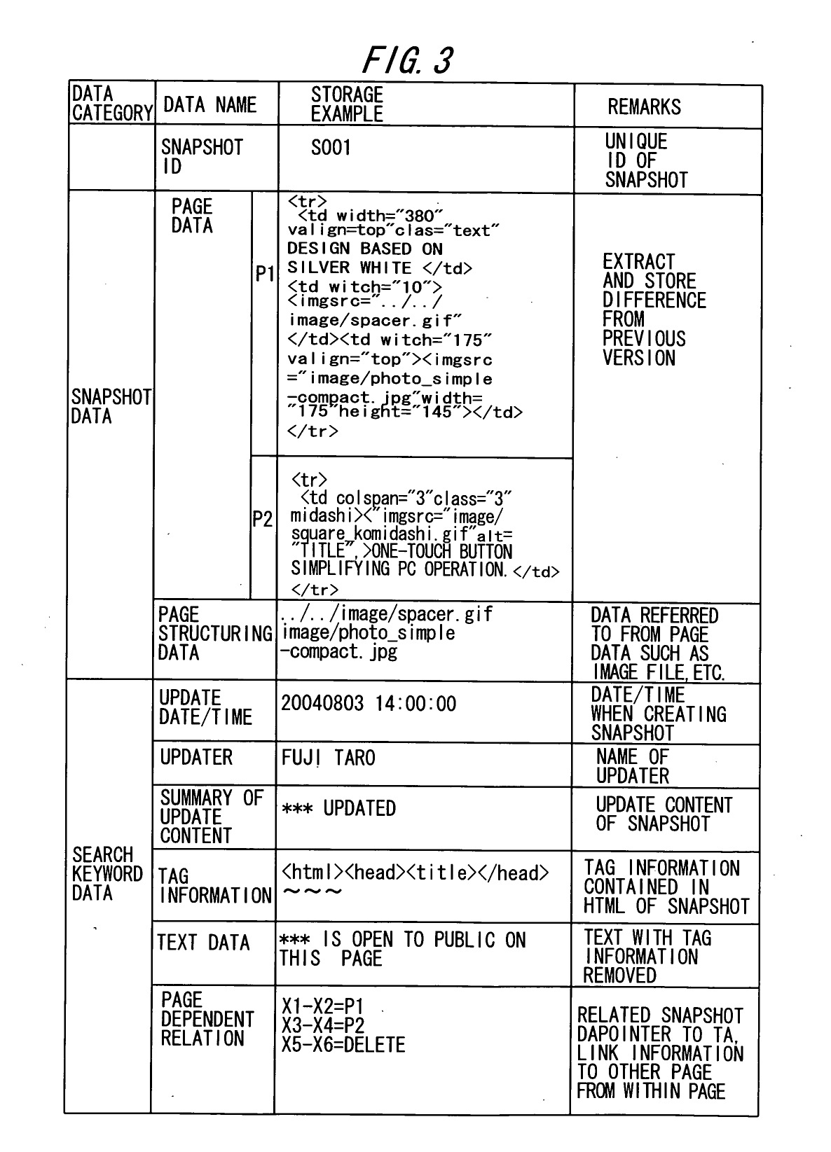

This history creation module 21, when updating the content stored on the storage 13 into a new content, compares the new content with a content (which will hereinafter be also referred to as a snapshot) for updating, thus creates data for the snapshot and data for searching as the history information, and stores the storage unit 13 with the history information. FIG. 3 is an explanatory diagram of this history information. The data for the snapshot in this example consists of a snapshot ID (identifying information) for specifying the snapshot, difference data between the content when updating (a Web page text when updating) and the new content (a new Web page text), and page structuring data such as an image file, a voice file, etc. that are referred to from the difference data. Further, search keyword data consists of update date/time, an updater, an update content summary, tag information, text data and a page dependent relation.

The request accept module 22 receives the content request information from the user terminal 2.

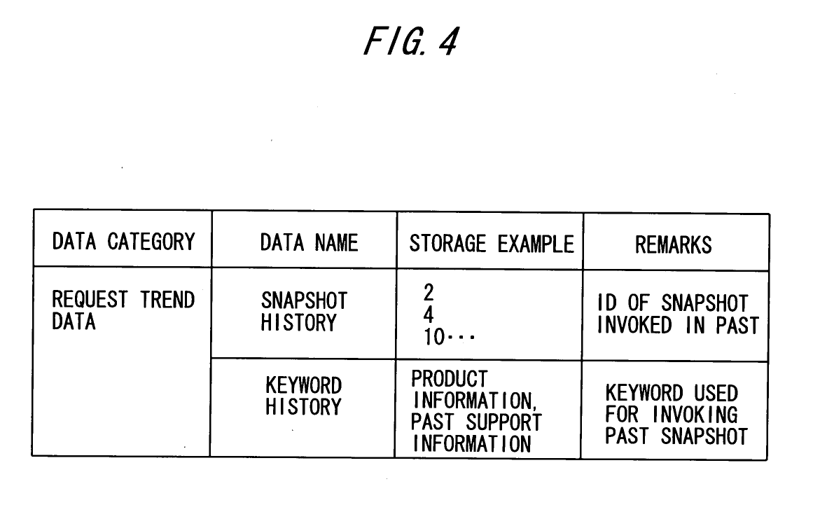

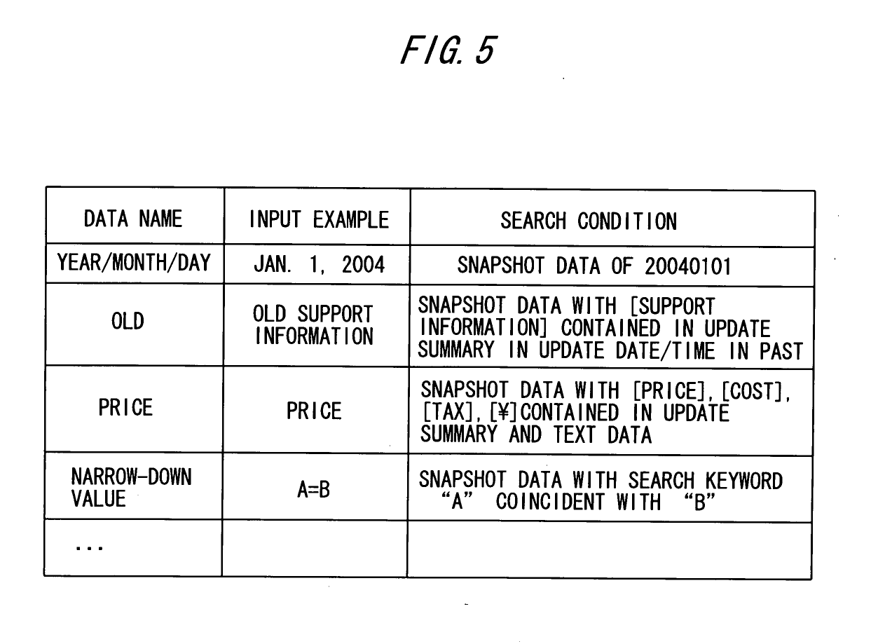

The search module 23 searches for the history information corresponding to the request information by referring to the storage unit 13. Further, the search module 23 acquires request trend data by executing a statistical process of the retrieved request information, and registers the request trend data on the storage unit 13. FIG. 4 is an explanatory diagram of the request trend data. The request trend data in this example is stored in a way that associates the keyword utilized in the past with the snapshot ID of the snapshot adopted when searched by use of this keyword. Moreover, other than the request trend data, the storage unit 13 is stored with lexical analysis data of the keyword used for searching for the snapshot. The lexical analysis data is data stored in a way that associates a presumed expressive variation and a proper search condition with each other in consideration of a variation of the search keyword. FIG. 5 is an explanatory diagram of the lexical analysis data. The search module 23, when the keyword is inputted, extracts the search condition associated with this keyword by referring to the lexical analysis data, and does searching based on this search condition, thus enabling a fuzzy search.

The content regeneration module 24 regenerates the past content (snapshot) by reflecting the history information drawn out as a result of the search in a post-updating page (a page with a difference taken).

The providing module 25 provides (transmits) the regenerated content to the user terminal 2 of the requester.

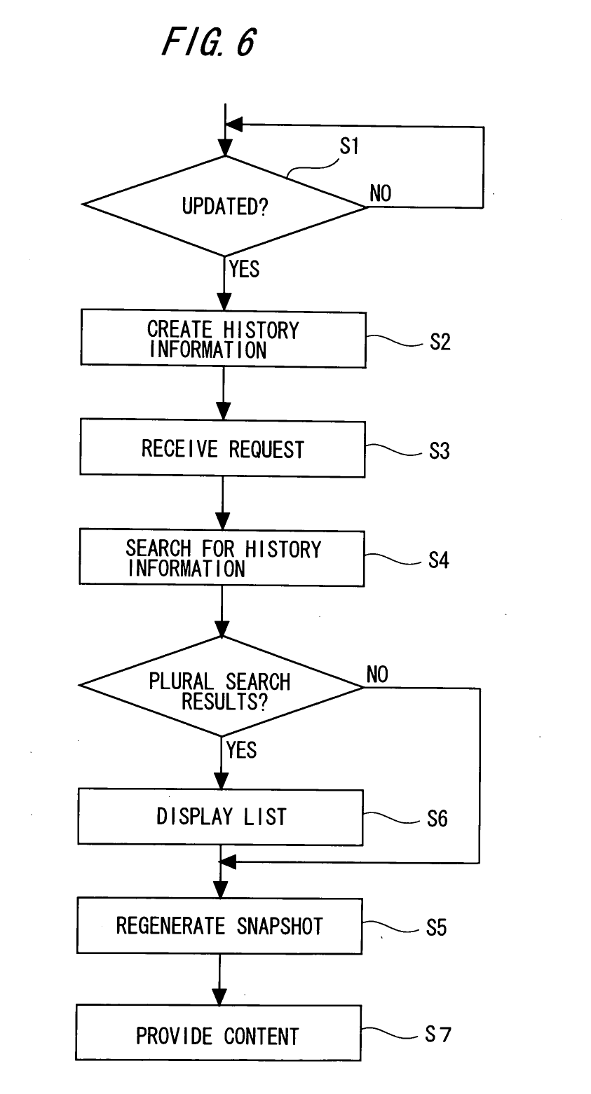

Given next in the following discussion is a content management method executed by the public server 1 through the functions of the respective modules based on the content management program. FIG. 6 is an explanatory diagram of the content management method in the embodiment.

The public server 1 always checks the contents stored (step 1, which will hereinafter be abbreviated such as S1), and the history creation module 21, if the content is changed, creates the history information (S2). For instance, if the new content is uploaded and overwritten on the present content and if the present content is edited and stored by overwriting, the OS detects this updating, and the history creation module 21 acquires the [snapshot data] and the [search keyword data] by comparing the new content with the present content at the present (when updating) and stores these pieces of data on the storage unit 13. In the example in FIG. 3, [S001] is registered as the snapshot ID, [P1, P2] is registered as the difference data (the page data), and [../../image/spacer.gif, image/photo#simple-compact.jpg] is registered as the page structuring data. Further, the history creation module 21 attaches a tag set “X1-Xn” indicating an updating area to the new content (the post-updating content) in order to regenerate the snapshot. For example, the tag “X1” is attached to a start position of a segment corresponding to the difference data P1, and the tag “X2” is attached to an end position thereof. The tag “X3” is attached to a start position of a segment corresponding to the difference data P2, and the tag “X4” is attached to an end position thereof. The tag “X5” is attached to a start position of a segment that does not exist in the pre-updating content but is added afresh to the post-updating content, and the tag “X6” is attached to an end position thereof. Then, the history creation module 21 stores the storage unit 13 with X1-X2=P1, X3-X4 =P2, X5-X6=Delete, etc. as the page dependent relation thereof.

Note that the public server 1 is, without being limited to providing the snapshot based on the history information automatically created when updating, also capable of providing an arbitrary snapshot based on the snapshot data and the search keyword created newly by the content producer. Moreover, the public server 1 includes a user interface for editing and deleting the [snapshot data] and the [search keyword data] registered on the storage unit 13, and can provide the snapshot based on the history information edited by the content producer and also can stop providing the snapshot by deleting the history information.

Then, when receiving the request information for the past content from the user terminal 2 (S3), the public server 1 searches through the storage unit 13 for the history information corresponding to this request information (S4). If the history information drawn out by this search is a single piece of information, the public server 1 regenerates the snapshot based on this piece the history information (S5). On the other hand if the history information drawn out is plural pieces of information, the public server 1 displays, to the requester user terminal 2, a list of titles, display samples, abstracts of the texts containing the keywords, an update summary, etc. with respect to part or the whole of these pieces of history information (S6). Herein, the public server 1 displays, based on the request rend data, the history information in sequence according to an adoption frequency from the highest. Furthermore, the public server 1 may also obtain a score of degree of fitness to the keyword requested for every piece of history information, and may display the information in sequence according to the score from the highest (from the highest degree of fitness).

When the user selects the history information to be adopted from this list and receives from the user terminal 2 a piece of information indicating which history information is selected, the public server 1 draws out the snapshot data as the selected history information and also the post-updating page data, and regenerates the pre-updating page by reflecting the difference data in the post-updating page data (S5). In the example in FIG. 3, the data defined by the tags “X1 through X2” in the post-updating content is replaced with the difference data P1, the data defined by the tags “X3 through X4” is replaced with the difference data P2, and the data defined by the tags “X5 through X6” is deleted. Moreover, the search module 23 executes the statistical process by counting an event that this piece of history information is adopted for the regeneration with respect to the keyword, acquires a degree of probability, as a piece of request trend data, that the history information is adopted when the keyword is inputted, and thus updates the request trend data on the storage unit 13.

Then, the public server 1 transmits the regenerated content to the requester usr terminal 2 (S7).

Next, a specific search example will be explained.

For instance, a URL of the Web page (the content) describing the latest product information is http://hogehoge/page/html, and, when desiring to search for the information described on this page in the past, the content is requested in a way that enters this URL and a keyword into a URL input box on Web Browser.

The keyword input method in the embodiment involves putting a predetermined delimiter “?” after the URL, and inputting the search keyword posterior to this delimiter.

### EXAMPLE 1

http://hogehoge/page/html?SearchKeyword.

Further, a plurality of search keywords can be also inputted.

### EXAMPLE 2

http://hogehoge/page/html?SearchKeyword1&SearchKeyword2.

### EXAMPLE 3

http://hogehoge/page/html?SearchKeyword1orSearchKeyword2.

Moreover, the search target can be arbitrarily narrowed down.

### EXAMPLE 4

http://hogehoge/page/html?UpdateDate=March2004 (which is an example of searching for only the data updated in March in 2004)

### EXAMPLE 5

http://hogehoge/page/html?Title=SummerModel (which is an example of searching for only the data with “Summer Model” contained in the title)

Note that the keyword input method is not limited to the method of inputting the information subsequent to the URL, and there may be provided a keyword input box into which the information may be inputted. In this case, the URL and the keyword may be inputted together, and all the URLs may also be searched for by inputting only the keyword.

Thus, according to the embodiment, the difference (data) of the past content is stored together with the keyword as the history information, and the past content can be provided based on the history information. Hence, there is no necessity of storing again the past content in a way that changes the URL, and it is possible to simplify the configuration of the site and to reduce a labor for maintenance. Further, in the case of storing the past contents according to every piece of index information such as the date information, etc. by converting the contents into the image files as done by the prior arts, the searching must be performed invariably based on the index information. According to the embodiment, however, the difference data and the page structuring data remain undeleted, and therefore the searching can flexibly be done in the same way as on the normal Web page.

On the other hand, the user can do the normal Web Browsing manipulation without being aware of its being the snapshot.

<Others>

The invention is not limited to only the illustrated examples given above and can be, as a matter of course, changed in a variety of forms within the scope that does not deviate from the gist of the invention.

For example, the same effects as those in the embodiment discussed above are acquired from the configurations given in the following Notes. Further, the components thereof can be combined to the greatest possible degree.

The disclosures of Japanese patent application No. JP2004-376420 filed on Dec. 27, 2004 including the specification, drawings and abstract are incorporated herein by reference.

What is claimed is:

1. A content management device comprising:
a storage unit storing a content;
a history creation module creating, when updating the content stored on said storage unit into a new content, history information by comparing the new content with a content when updating;
a request accept module receiving request information for the content; and
a search module searching said storage unit for the history information corresponding to the request information.

2. A content management device according to claim 1, further comprising:
a content regeneration module regenerating the content based on the history information as a result of the search; and
a providing module providing the regenerated content to a requester.

3. A content management device according to claim 1, wherein said history creation module compares the new content with the content when updating, and thus creates difference data between the two contents and search data as the history information.

4. A content management device according to claim 1, wherein said search module acquires request trend data by executing a statistical process of the retrieved request information, and registers the request trend data on said storage unit.

5. A content management method comprising steps of:
creating, when updating a content stored on a storage unit into a new content, history information by comparing the new content with a content when updating;
receiving request information for the content; and
searching said storage unit for the history information corresponding to the request information.

6. A content management method according to claim 5, further comprising steps of:
regenerating the content based on the history information as a result of the search; and
providing the regenerated content to a requester.

7. A content management method according to claim 5, wherein said history information creating step involves comparing the new content with the content when updating, and thus creating difference data between the two contents and search data as the history information.

8. A content management method according to claim 5, wherein said history information searching step involves acquiring request trend data by executing a statistical process of the retrieved request information, and storing the request trend data on said storage unit.

9. A recording medium recorded with a content management program for making a computer execute steps of:
creating, when updating a content stored on a storage unit into a new content, history information by comparing the new content with a content when updating;
receiving request information for the content; and
searching said storage unit for the history information corresponding to the request information.

10. A recording medium according to claim 9, wherein said computer is made to further execute steps of:
regenerating the content based on the history information as a result of the search; and
providing the regenerated content to a requester.

11. A recording medium according to claim 9, wherein said history information creating step involves comparing the new content with the content when updating, and thus creating difference data between the two contents and search data as the history information.

12. A recording medium according to claim 9, wherein said history information searching step involves acquiring request trend data by executing a statistical process of the retrieved request information, and storing the request trend data on said storage unit.
